(19) United States
(12) Patent Application Publication
(10) Pub. No.: US 2019/0078907 A1
(43) Pub. Date: Mar. 14, 2019

(54) NAVIGATION DEVICE

(71) Applicant: TOYOTA JIDOSHA KABUSHIKI KAISHA, Toyota-shi (JP)

(72) Inventors: Miharu HANAI, Obu-shi (JP); Daisuke HIGASHI, Minato-ku (JP)

(73) Assignee: TOYOTA JIDOSHA KABUSHIKI KAISHA, Toyota-shi (JP)

(21) Appl. No.: 16/123,595

(22) Filed: Sep. 6, 2018

(30) Foreign Application Priority Data
Sep. 8, 2017 (JP) 2017-173343

(51) Int. Cl. G01C 21/36

(52) U.S. Cl. CPC G01C 21/3676; G01C 21/3664; G01C 21/367

(57) ABSTRACT

A navigation device includes a display unit, an operation detection unit configured to detect a predetermined random display operation in the navigation device, and a display controller configured to make the display unit display one search theme-specific route among a plurality of search theme-specific routes searched by an internal or external route search unit. The display controller switches a route displayed on the display unit to another search theme-specific route among the search theme-specific routes each time the predetermined random display operation is detected by the operation detection unit.

### INCORPORATION BY REFERENCE

The disclosure of Japanese Patent Application No. 2017-173343 filed on Sep. 8, 2017 including the specification, drawings and abstract is incorporated herein by reference in its entirety.

### BACKGROUND

### 1. Technical Field

The present disclosure relates to a navigation device.

### 2. Description of Related Art

According to the related art, in a general navigation device, a plurality of routes to a destination can be searched while a search condition (for example, distance preference, general road preference, expressway preference, and the like) varies, and route guidance to the destination can be performed using a route selected by a user among the routes.

Japanese Unexamined Patent Application Publication No. 2012-098065 (JP 2012-098065 A) discloses a technique that, in a navigation device, calculates a plurality of routes to a plurality of destination candidates as a destination candidate route, makes a display unit display the routes, and sets one route selected from among the routes as a route to be guided.

### SUMMARY

On the other hand, according to the related art, a technique that searches for the routes with different search conditions (however, a departure place and a destination are identical), and sequentially switches and displays the routes is known. However, according to the related art, even though display switching of the routes is performed, in many cases, a route similar to a route previously displayed is next displayed. For this reason, a user may not easily distinguish the differences among the routes and may not easily determine a route to select.

The present disclosure provides a navigation device capable of switching and displaying a plurality of routes such that a user can easily distinguish the differences among the routes.

An aspect of the present disclosure relates to a navigation device including a display unit, an operation detection unit, and a display controller. The operation detection unit configured to detect a predetermined random display operation in the navigation device. The display controller is configured to make the display unit display one search theme-specific route among a plurality of search theme-specific routes searched by an internal or external route search unit. The display controller switches a route displayed on the display unit to another search theme-specific route among the search theme-specific routes each time the predetermined random display operation is detected by the operation detection unit.

According to the aspect of the present disclosure, a point and a road to go through vary greatly between a route previously displayed and a route next displayed as the search theme changes. For this reason, it is possible to allow the user to easily distinguish the differences among the routes. Accordingly, it is possible to switch and display the routes such that the user can easily distinguish the differences among the routes.

In the navigation device according to the aspect of the present disclosure, the predetermined random display operation may be a shake operation of the navigation device.

According to the aspect of the present disclosure, the user can easily and intuitively switch a route displayed on the display unit. That is, switching of a route displayed on the display unit is performed at a short time interval. For this reason, it is possible to allow the user to easily distinguish the differences among the routes. In particular, the effect described above is useful.

In the navigation device according to the aspect of the present disclosure, the display controller may make another search theme-specific route having a larger route difference from one search theme-specific route previously displayed be next displayed in a preferential manner in performing display switching of the search theme-specific routes.

According to the aspect of the present disclosure, the point and the road to go through vary greatly between the route previously displayed and the route next displayed as the search theme changes. For this reason, it is possible to allow the user to easily distinguish the differences among the routes. Accordingly, it is possible to switch and display the routes such that the user can easily distinguish the routes.

It is possible to switch and display a plurality of routes such that the user can easily distinguish the differences among the routes.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing a system configuration of a navigation system according to an embodiment;

FIG. 2 is a sequence diagram showing a procedure of processing in a smartphone and a center server according to the embodiment;

FIG. 3 is a flowchart showing a procedure of processing with a control device of the smartphone according to the embodiment;

FIG. 4 is a diagram showing an example of a display switching operation of a route with the smartphone according to the embodiment;

FIG. 5A is a diagram showing an example of a plurality of search themes defined in advance in the center server according to the embodiment in a stepwise manner;

FIG. 5B is a diagram showing an example of a display switching operation of search theme-specific routes with the smartphone according to the embodiment; and

FIG. 6 is a table showing an example of a search condition that is applied by vehicle type in the navigation system according to the embodiment.

### DETAILED DESCRIPTION OF EMBODIMENTS

Hereinafter, a navigation system according to an embodiment of the present disclosure will be described referring to the drawings.

### System Configuration of Navigation System 10

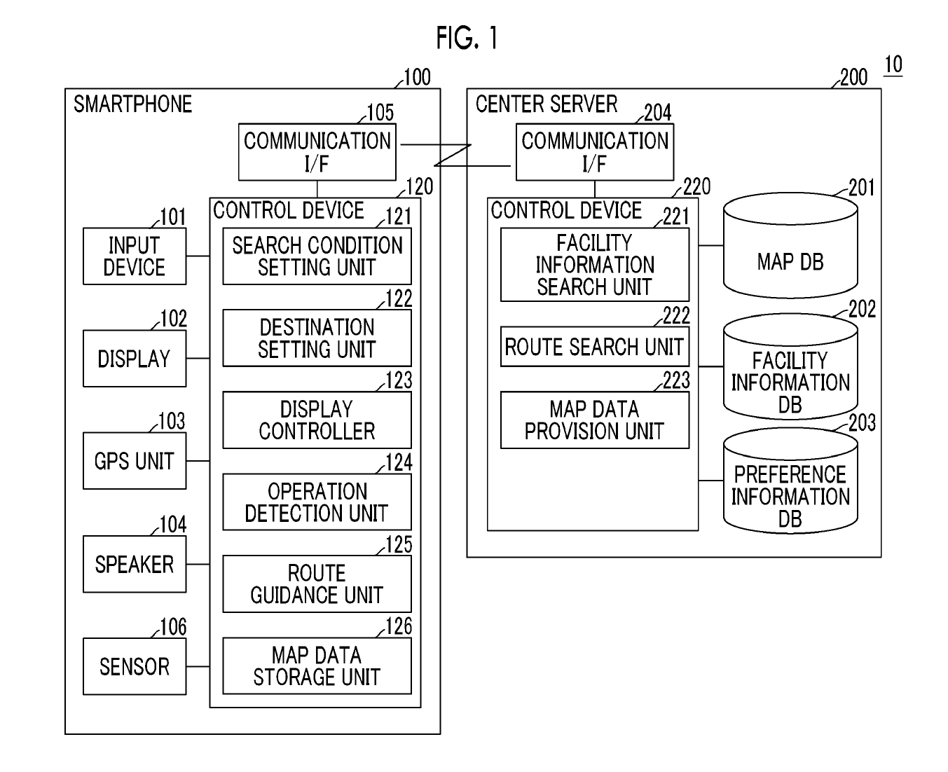

FIG. 1 is a diagram showing the system configuration of a navigation system 10 according to the embodiment. The navigation system 10 shown in FIG. 1 includes a smartphone 100 and a center server 200. The navigation system 10 is a system that can provide information, such as facility information or a route to a destination conforming to a search condition designated by a user from the center server 200 to the smartphone 100 using a navigation service of the center server 200 from a navigation application of the smartphone 100. That is, the center server 200 functions as a navigation server, and the smartphone 100 functions as a navigation terminal.

In FIG. 1, although one smartphone 100 is shown, actually, the navigation system 10 includes a plurality of smartphones 100 (all have the same configuration as the smartphone 100 shown in FIG. 1). That is, in the navigation system 10, the navigation service of the center server 200 is usable from the smartphones 100 (a plurality of users).

### Center Server 200

The center server 200 is an apparatus that is provided inside a facility (for example, a facility that is managed by a navigation service provider) outside a vehicle.

The center server 200 can provide various pieces of information (for example, facility information, route information, and the like) to the smartphone 100 through wireless communication (for example, Wi-Fi (Registered Trademark) or the like) with the smartphone 100.

As shown in FIG. 1, the center server 200 includes a map database (DB) 201, a facility information DB 202, a preference information DB 203, a communication interface (I/F) 204, and a control device 220.

The map DB 201 stores map data. Map data includes a plurality of pieces of node data and a plurality of pieces of link data. Node data is data corresponding to an intersection. Link data is data corresponding to a road section between a node and a node.

The facility information DB 202 stores a plurality of pieces of facility information. For example, each piece of facility information includes a facility name, positional information (latitude and longitude), a genre, an address, a postal code, a telephone number, a detailed comment, an image, and the like.

The preference information DB 203 stores a plurality of pieces of preference information of each user (specifically, a user ID (identifier) allocated to each user). For example, each piece of preference information includes information regarding a genre, an area, a facility, and the like preferred by the user. Each piece of preference information may include information fixedly set through a keyword input or the like, or may include information dynamically set from information regarding a search history of a destination through known analysis processing or the like.

The communication I/F 204 performs transmission and reception of various pieces of data to and from the smartphone 100 by controlling communication with the smartphone 100 through wireless communication.

The control device 220 is a device that controls processing on the center server 200 side when the user uses the navigation service from the smartphone 100. As shown in FIG. 1, the control device 220 includes, as functions thereof, a facility information search unit 221, a route search unit 222, and a map data provision unit 223.

In a case where a search request of facility information is received from the smartphone 100, the facility information search unit 221 searches for the pieces of facility information conforming to a search condition included in the search request from the facility information DB 202. The pieces of facility information searched by the facility information search unit 221 is provided to the smartphone 100 and is displayed on a display 102 of the smartphone 100 to be presented to the user. The user can select any desired facility information from among the pieces of presented facility information as a destination of route guidance.

In a case where a route search request is received from the smartphone 100, the route search unit 222 searches for a route from a present place of the smartphone 100 specified by present place information included in the route search request to a destination specified by destination information included in the route search request based on map data stored in the map DB 201.

Here, the route search unit 222 can search for a plurality of search theme-specific routes along with a recommended route (a recommended route according to a vehicle type).

For example, in regard to a recommended route (a recommended route according to a vehicle type), the route search unit 222 searches for a route through a road suitable for a vehicle type (for example, a vehicle type associated with a user ID) of a host vehicle. For example, in a case of a comparatively large vehicle type, a route through a comparatively wide road, not through a comparatively narrow road, is searched.

For example, in regard to each search theme-specific route, the route search unit 222 searches for a route through a point (for example, scenery, food, pleasure, or the like) or a road (for example, general road, expressway, straight road, or the like) related to the search theme. For example, in a case where a search theme-specific route with a search theme “favorite route” is searched, when the preference of the user is “mountain road”, “Italian food”, and “flower”, the route search unit 222 searches for a route through a point (for example, an Italian restaurant, a flower garden, or the like) or a road (for example, a road over a mountain road or the like) related to the preference of the user. The route search unit 222 can specify the preference of the user based on the preference information of the user stored in the preference information DB 203. The search theme “favorite route” may be classified into a plurality of search themes confined to a specific genre, such as “favorite route (food-oriented)” and “favorite route (scenery-oriented)”.

The route search unit 222 may search for a recommended route through a facility related to the destination according to the destination. For example, in a case where the destination is a “campground”, a recommended route through a supermarket for purchase of foodstuffs or the like is searched.

A plurality of routes searched by the route search unit 222 is provided to the smartphone 100 and is displayed on the display 102 of the smartphone 100 to be presented to the user. The user can select one desired route from among the presented routes as a route for use in route guidance.

When the smartphone 100 displays a map screen of which map data is not stored in the smartphone 100, the map data provision unit 223 provides map data of the map screen to the smartphone 100.

The control device 220 is constituted by hardware, such as a central processing unit (CPU), a main storage device (for example, a read only memory (ROM), a random access memory (RAM), or the like), an auxiliary storage device (for example, a hard disk drive (HDD), a flash memory, or the like). The functions of the control device 220 are realized by, in the control device 220, the CPU executing a program stored in the main storage device or the auxiliary storage device, for example.

The center server 200 may be physically constituted by one information processing apparatus or may be physically constituted by a plurality of information processing apparatuses. In the latter case, the information processing apparatuses may be connected to one another through a network.

### Smartphone 100

The smartphone 100 is a portable terminal that is carried with the user. The smartphone 100 can receive various pieces of information (for example, facility information, route information, and the like) provided from the center server 200 through a wireless communication line (for example, a mobile phone network with a base station as a terminal, Wi-Fi, or the like) with the center server 200.

The smartphone 100 can set a destination based on the facility information provided from the center server 200 and can request the center server 200 to search a route search to the destination. Then, the smartphone 100 can perform route guidance to the destination based on the route searched by the center server 200.

As shown in FIG. 1, the smartphone 100 includes an input device 101, a display 102, a global positioning system (GPS) unit 103, a speaker 104, a communication I/F 105, a sensor 106, and a control device 120 as devices related to the use of the navigation service.

The input device 101 is a device that is used when the user performs an input (for example, an input of a search condition, a setting of a destination, and the like) of various pieces of information. In the embodiment, although a touch panel is used as the input device 101, a device (for example, an operation button, a cross key, an audio input device (microphone), or the like) other than the touch panel may be used.

The display 102 is an example of a “display unit”, and is a device that displays various pieces of information (for example, a map screen, a search condition input screen, facility information, a route search result, a guidance screen at the time of route guidance, and the like). As the display 102, for example, a liquid crystal display, an organic electroluminescence (EL) display, or the like is exemplified. The GPS unit 103 detects a present place (latitude and longitude) of the smartphone 100 based on GPS signal received from GPS satellites. The speaker 104 is a device that outputs various voices (for example, a guidance voice at the time of route guidance, and the like). The communication 1/F 105 performs transmission and reception of various pieces of data to and from the center server 200 by controlling communication with the center server 200 through wireless communication.

The sensor 106 detects an operation of a body of the smartphone 100 and outputs a detection value according to the operation. As the sensor 106, for example, an acceleration sensor can be used. In this case, the sensor 106 detects an acceleration of the body of the smartphone 100 and outputs a detection value according to the acceleration.

The control device 120 is a device that controls processing on the smartphone 100 side when the user uses the navigation service from the smartphone 100. As shown in FIG. 1, the control device 120 includes a search condition setting unit 121, a destination setting unit 122, a display controller 123, an operation detection unit 124, a route guidance unit 125, and a map data storage unit 126.

The search condition setting unit 121 sets a search condition of facility information based on a user input. As the search condition of facility information, for example, a facility name, a genre, an area, a telephone number, and the like are exemplified. In a case where a search condition is set by the search condition setting unit 121, the communication I/F 105 transmits a search request of facility information including the search condition to the center server 200.

The destination setting unit 122 sets, as a destination, a point (a present place of a facility) corresponding to facility information selected by the user from among the pieces of facility information searched by the center server 200 (facility information search unit 221). In a case where a destination is set by the destination setting unit 122, the communication I/F 105 transmits a route search request including destination information indicating the destination and present place information indicating the present place of the smartphone 100 detected by the GPS unit 103 to the center server 200.

The display controller 123 controls display of various pieces of information on the display 102.

For example, in regard to a map screen to be initially displayed, the display controller 123 makes the display 102 display the map screen based on map data provided from the center server 200 (map data provision unit 223).

For example, in regard to a map screen to be displayed after the second time, the display controller 123 makes the display 102 display the map screen based on map data stored in the map data storage unit 126.

For example, the display controller 123 makes the display 102 display the pieces of facility information searched by the center server 200 (facility information search unit 221). For example, the display controller 123 displays the pieces of facility information searched by the center server 200 in the form of a list. In a case where the user selects one piece of facility information from among the pieces of facility information displayed in the form of a list, the display controller 123 makes the display 102 display detailed information of the facility information.

For example, the display controller 123 makes the display 102 display the routes searched by the center server 200 (route search unit 222). In particular, the display controller 123 can make the display 102 switch and display the search theme-specific routes searched by the center server 200 for each search theme. Specifically, first, the display controller 123 makes the display 102 display an overall process view of one search theme-specific route (for example, a recommended route according to a vehicle type) among the search theme-specific routes searched by the center server 200. Then, the display controller 123 switches a route displayed on the display 102 to another search theme-specific route among the search theme-specific routes each time a shake operation of the body of the smartphone 100 is detected by the operation detection unit 124. When one search theme-specific route is displayed on the display 102, the user performs a predetermined selection operation, thereby establishing the search theme-specific route as a route for use in route guidance.

The operation detection unit 124 detects the shake operation of the body of the smartphone 100. Specifically, the operation detection unit 124 determines that the shake operation of the body of the smartphone 100 is performed in a case where a change pattern of a detection value (a detection value according to an operation of the body of the smartphone 100) output from the sensor 106 indicates a predetermined change pattern corresponding to the shake operation of the body of the smartphone 100. The shake operation is an operation to reciprocate the body of the smartphone 100 in one direction at least one or more times.

The route guidance unit 125 performs, based on one route selected by the user among the routes searched by the center server 200, route guidance from a departure place to a destination of the route. Route guidance of the route guidance unit 125 is accompanied with display of a guidance screen on the display 102 and output of a guidance voice from the speaker 104. The center server 200 (route search unit 222) can perform route search with a point (a point optionally designated by the user) other than the present place of the smartphone 100 as a departure place. With the above, the route guidance unit 125 can perform route guidance with a point other than the present place of the smartphone 100 as a departure place.

The map data storage unit 126 stores map data provided from the center server 200 (map data provision unit 223). With the above, in regard to a map screen displayed once, the display controller 123 can make the map screen be displayed again based on map data stored in the map data storage unit 126. Accordingly, it is possible to suppress a communication frequency with the center server 200, and to obtain effects, such as improvement of a display speed of a map screen.

The control device 120 is constituted by hardware, such as a CPU, a main storage device (for example, a ROM, a RAM, or the like), and an auxiliary storage device (for example, an HDD, a flash memory, or the like). The functions of the control device 120 shown in FIG. 1 are realized by, in the control device 120, the CPU executing a program stored in the main storage device or the auxiliary storage device, for example.

The program that the CPU executes may be provided in a state of being introduced into the smartphone 100 in advance or may be provided from the outside and introduced into the smartphone 100. In the latter case, the program may be provided through an external storage medium (for example, a universal serial bus (USB) memory, a memory card, a compact disc read only memory (CD-ROM), or the like) or may be downloaded and provided from a server on a network (for example, the Internet or the like).

### Procedure of Processing in Smartphone 100 and Center Server 200

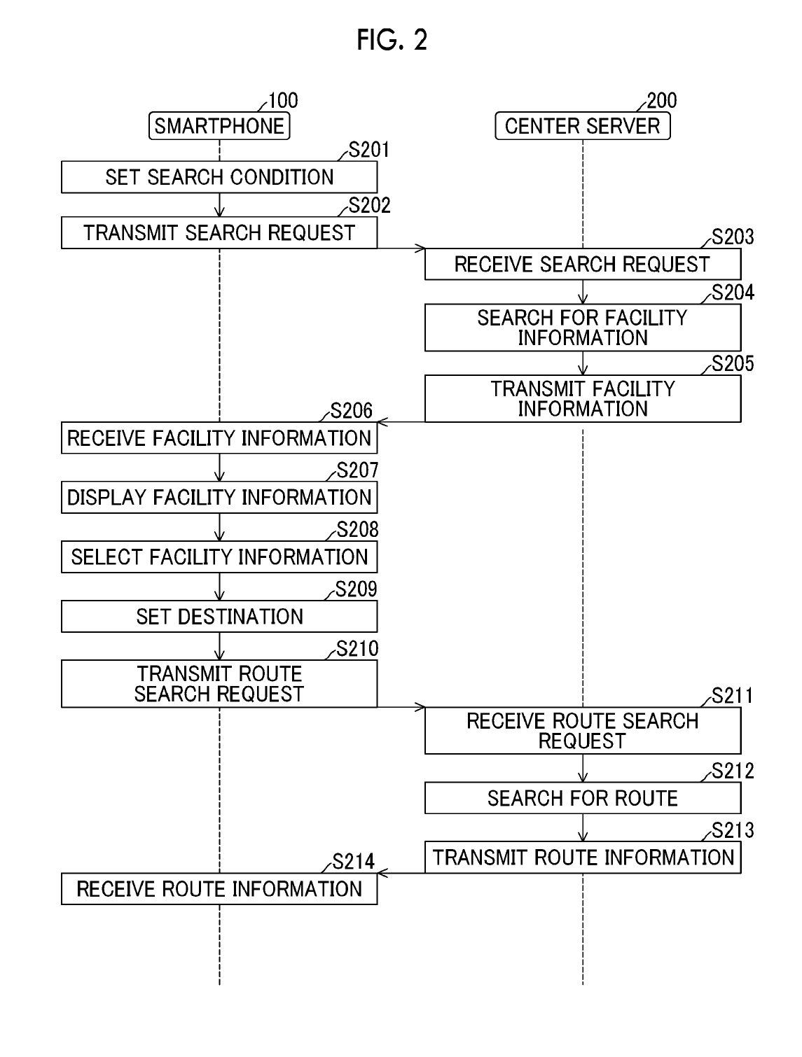

FIG. 2 is a sequence diagram showing a procedure of processing in the smartphone 100 and the center server 200 according to the embodiment. The processing shown in FIG. 2 is processing the user inputs the search condition of facility information to the smartphone 100 until the smartphone 100 receives the routes searched by the center server 200. The processing shown in FIG. 2 is started, for example, in a case where a predetermined user operation (for example, depression of a destination setting button) for destination setting is performed in the smartphone 100.

First, in the smartphone 100, the search condition setting unit 121 sets a search condition of facility information based on a user input (Step S201). The communication I/F 105 transmits a search request of facility information including the search condition set in Step 5201 to the center server 200 (Step S202).

In the center server 200, in a case where the communication I/F 204 receives the search request transmitted from the smartphone 100 (Step S203), the facility information search unit 221 searches for facility information conforming to the search condition included in the search request from the facility information DB 202 (Step S204). Then, the communication I/F 204 transmits the facility information searched in Step S204 to the smartphone 100 (Step S205).

In the smartphone 100, in a case where the communication I/F 105 receives the facility information transmitted from the center server 200 (Step S206), the display controller 123 makes the display 102 display the facility information (Step S207).

Thereafter, in a case where the destination setting unit 122 detects that one piece of facility information is selected from among the facility information displayed in Step S207 (Step S208), the destination setting unit 122 sets a point (for example, a location of a facility) corresponding to the selected facility information as a destination (Step S209). Then, the communication I/F 105 includes destination information indicating the destination set in Step S209 and present place information indicating the present place of the smartphone 100 detected by the GPS unit 103 in a route search request and transmits the route search request to the center server 200 (Step S210).

In the center server 200, in a case where the communication I/F 204 receives the route search request transmitted from the smartphone 100 (Step S211), the route search unit 222 searches for a route from the present place of the smartphone 100 specified by the present place information included in the route search request to the destination specified by the destination information included in the route search request based on map data stored in the map DB 201 (Step S212). Here, the route search unit 222 searches for the search theme-specific routes along with a recommended route (a recommended route according to a vehicle type). Then, the communication I/F 204 transmits route information indicating the routes searched in Step S212 to the smartphone 100 (Step S213).

In the smartphone 100, in a case where the communication I/F 105 receives the route information transmitted from the center server 200 (Step S214), a series of processing shown in FIG. 2 ends.

### Procedure of Processing in Control Device 120 of Smartphone 100

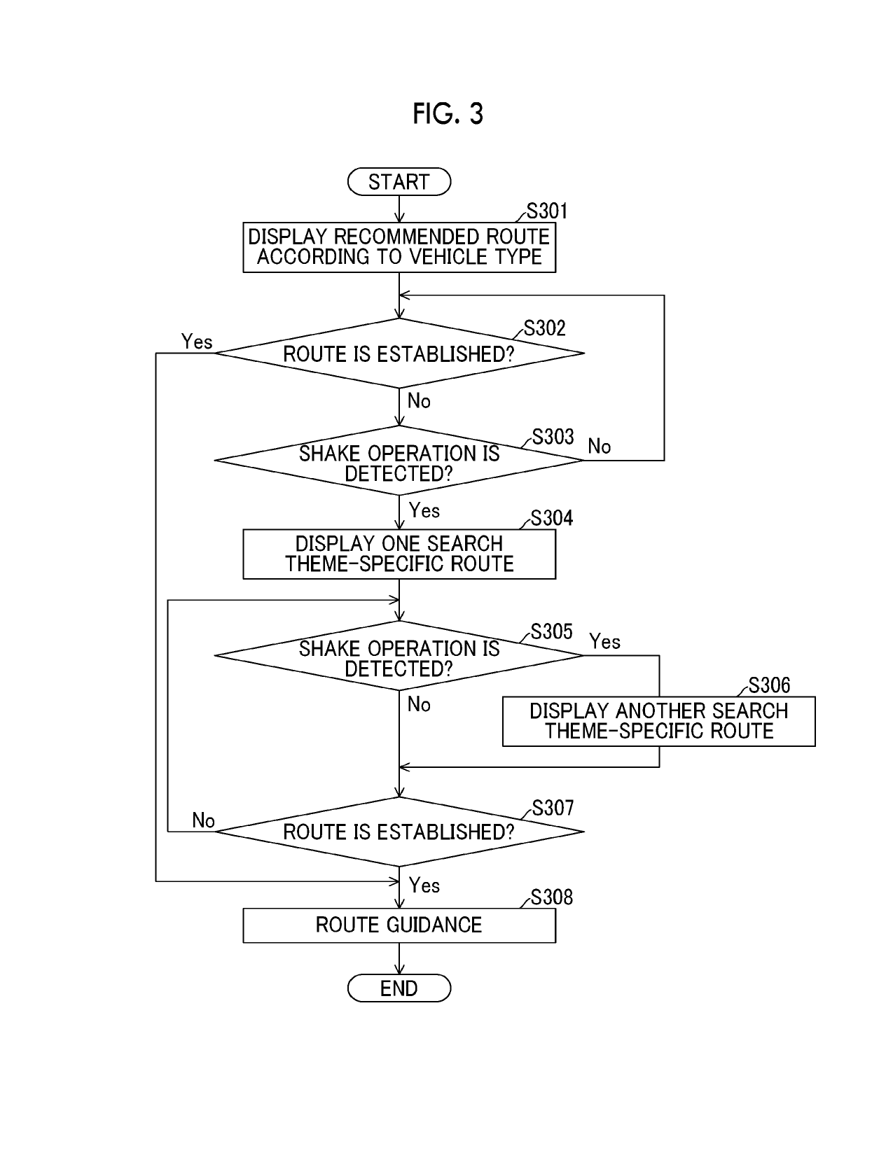

FIG. 3 is a flowchart showing a procedure of processing in the control device 120 of the smartphone 100 according to the embodiment. The processing shown in FIG. 3 is processing until the user selects one route from among the routes searched by the center server 200 and the control device 120 of the smartphone 100 performs route guidance using the route. For example, in a case where the smartphone 100 receives the routes through the processing shown in FIG. 2, the processing shown in FIG. 3 is started subsequently to the reception of the routes.

First, the display controller 123 makes the display 102 display an overall process view of a recommended route (a recommended route according to a vehicle type) among the routes searched by the center server 200 (Step S301).

Thereafter, the route guidance unit 125 determines whether or not the recommended route displayed on the display 102 is established as a route for use in route guidance (Step S302). For example, when a “guidance start button” displayed on the display 102 along with the recommended route is depressed, the recommended route is established as a route for use in route guidance.

In Step S302, in a case where determination is made that the recommended route is not established as a route for use in route guidance (Step S302: No), the control device 120 progresses the process to Step S303. In Step S302, in a case where determination is made that the recommended route is established as a route for use in route guidance (Step S302: Yes), the route guidance unit 125 performs, based on the recommended route, route guidance from a departure place to a destination of the recommended route (Step S308). Then, the control device 120 ends a series of processing shown in FIG. 3.

In Step S303, the operation detection unit 124 determines whether or not the shake operation of the body of the smartphone 100 is detected. In Step S303, in a case where determination is made that the shake operation is not detected (Step S303: No), the operation detection unit 124 returns the process to Step S302.

In Step S303, in a case where determination is made that the shake operation is detected (Step S303: Yes), the display controller 123 switches a route displayed on the display 102 to one search theme-specific route among the search theme-specific routes searched by the center server 200 (Step S304).

Thereafter, the operation detection unit 124 determines whether or not the shake operation of the body of the smartphone 100 is detected (Step S305). In Step S305, in a case where determination is made that the shake operation is not detected (Step S305: No), the control device 120 progresses the process to Step S307.

In Step S305, in a case where determination is made that the shake operation is detected (Step S305: Yes), the display controller 123 switches a route displayed on the display 102 to another search theme-specific route among the search theme-specific routes searched by the center server 200 (Step S306). Then, the control device 120 progresses the process to Step 5307.

In Step S307, the route guidance unit 125 determines whether or not the route displayed on the display 102 (one search theme-specific route) is established as a route for use in route guidance. For example, when the “guidance start button” displayed on the display 102 along with the route (one search theme-specific route) is depressed, the route is established as a route for use in route guidance.

In Step S307, in a case where determination is made that a route for use in route guidance is not established (Step S307: No), the control device 120 returns the process to Step S305. In Step S307, in a case where determination is made that a route for use in route guidance is established (Step S307: Yes), the route guidance unit 125 performs, based on the established route (one search theme-specific route), route guidance from a departure place to a destination of the route (Step S308). Then, the control device 120 ends a series of processing shown in FIG. 3.

### Example of Display Switching Operation of Route with Smartphone 100

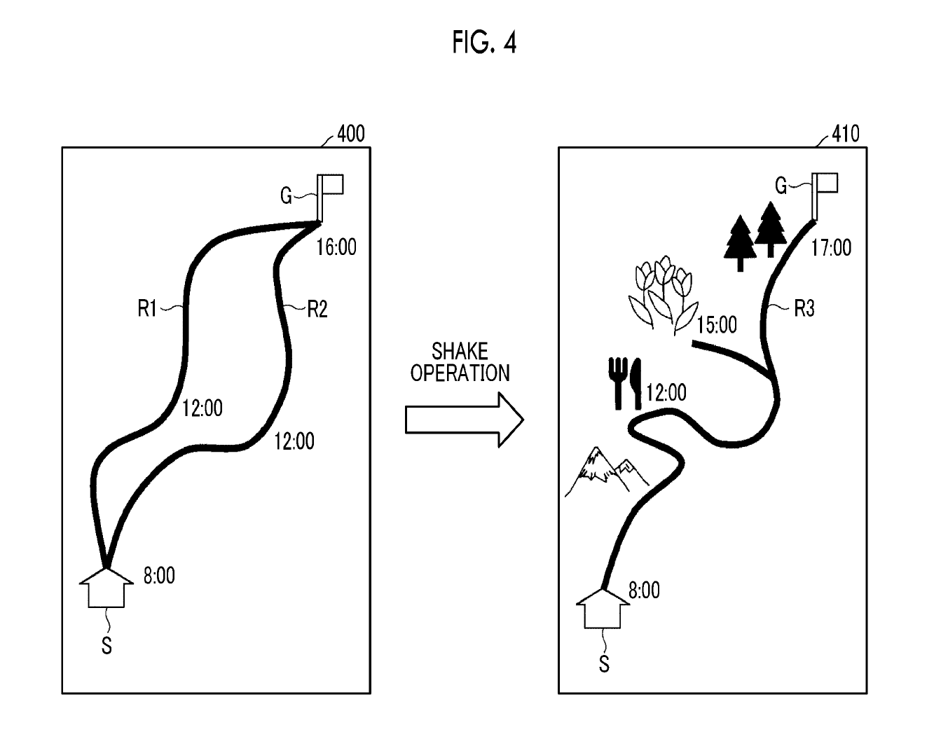

FIG. 4 is a diagram showing an example of a display switching operation of a route with the smartphone 100 according to the embodiment.

A display screen 400 shown on the left side of FIG. 4 is an example of a display screen of a recommended route (a recommended route according to a vehicle type) among the routes searched by the center server 200. In the example shown on the left side of FIG. 4, routes R1, R2 from a departure place S to a destination G are displayed on the display screen 400. Both of the routes R1, R2 are a recommended route (a recommended route according to a vehicle type) searched by the center server 200.

A display screen 410 shown on the right side of FIG. 4 is an example of a display screen of a search theme-specific route with the search theme “favorite route” among the routes searched by the center server 200. In the example shown on the right side of FIG. 4, a route R3 from the departure place S to the destination G is displayed on the display screen 400. The route R3 is a search theme-specific route searched by the center server 200 with the search theme as a “favorite route”.

For example, the smartphone 100 first makes the display 102 display the display screen 400. With the above, the routes R1, R2 as a recommended route (a recommended route according to a vehicle type) are displayed on the display 102.

Then, in a case where the shake operation of the body of the smartphone 100 is performed, the smartphone 100 switches a display screen displayed on the display 102 to the display screen 410. With the above, a route displayed on the display 102 is switched to the route R3 as a search theme-specific route with the search theme “favorite route”.

As described above, the user performs the shake operation of the body of the smartphone 100, thereby switching a display screen displayed on the display 102 from the display screen 400 of the routes R1, R2 as a recommended route (a recommended route according to a vehicle type) to the display screen 410 of the route R3 as a search theme-specific route.

Then, as shown on the left side of FIG. 4, when the routes R1, R2 are displayed, the user performs a predetermined selection operation, thereby selecting one of the routes R1, R2 as a route for use in route guidance. As shown on the right side of FIG. 4, when the route R3 is displayed, the user performs a predetermined selection operation, thereby selecting the route R3 as a route for use in route guidance.

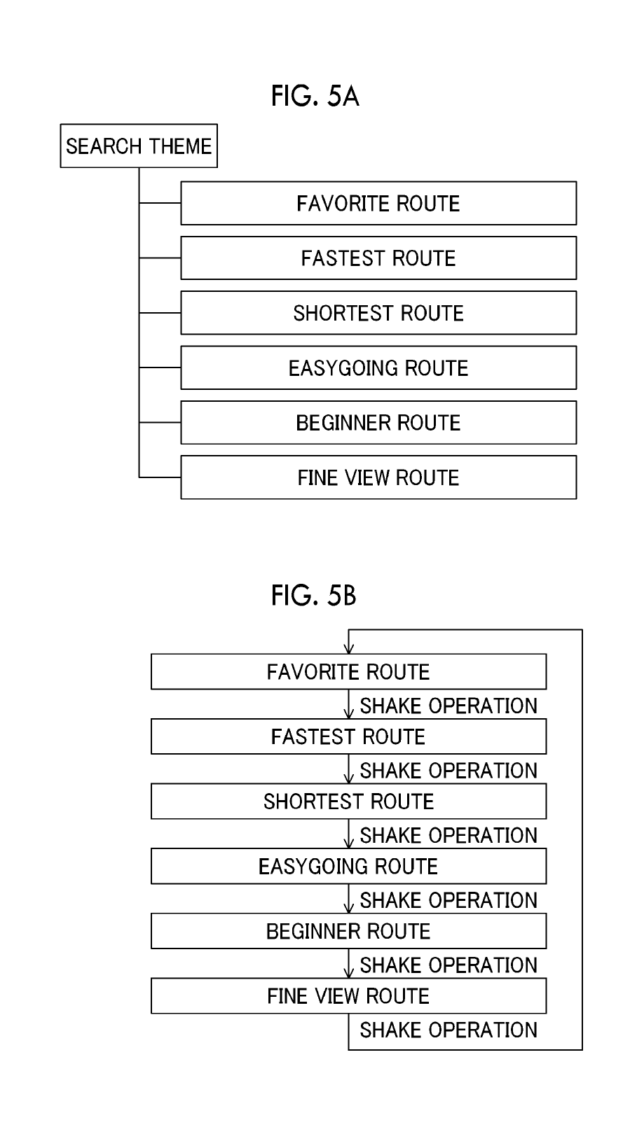

In a case where the shake operation of the body of the smartphone 100 is performed, as shown in FIGS. 5A and 5B, the smartphone 100 switches a display screen displayed on the display 102 to a display screen of another search theme-specific route. With the above, another search theme-specific route is displayed on the display 102.

### Example of Display Switching Operation of Search Theme-Specific Route with Smartphone 100

FIGS. 5A and 5B are diagrams showing an example of a display switching operation of a search theme-specific route with the smartphone 100 according to the embodiment.

In the navigation system 10 of the embodiment, when two or more search theme-specific routes are searched by the center server 200, the display controller 123 of the smartphone 100 makes the display 102 sequentially switch and display the two or more search theme-specific routes each time the shake operation of the body of the smartphone 100 is performed.

For example, FIG. 5A shows the search themes defined in advance in the center server 200 in a stepwise manner. In an example shown in FIG. 5A, the search themes include “favorite route”, “fastest route”, “shortest route”, “easygoing route”, “beginner route”, and “fine view route”. In this case, the center server 200 (route search unit 222) searches for a search theme-specific route for each of the search themes. Then, as shown in FIG. 5B, the smartphone 100 (display controller 123) can make the display 102 sequentially switch and display the search theme-specific routes searched by the center server 200 one by one each time the shake operation of the body of the smartphone 100 is performed.

In performing display switching the search theme-specific routes, the display controller 123 makes another search theme-specific route having a larger route difference from one search theme-specific route previously displayed be next displayed in a preferential manner. “Another search theme-specific route having a larger route difference” is, for example, another search theme-specific route having a longer total distance of a section not coinciding with one search theme-specific route previously displayed, another search theme-specific route having a larger maximum spaced distance of a section not coinciding with one search theme-specific route previously displayed, another search theme-specific route having a larger maximum spaced distance between via-points than one search theme-specific route previously displayed, or the like.

### Example of Search Condition Applied by Vehicle Type

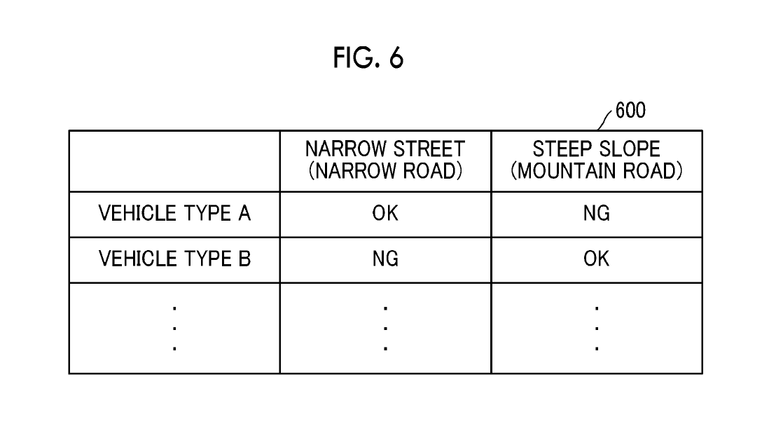

FIG. 6 is a table showing an example of a search condition that is applied by vehicle type in the navigation system 10 according to the embodiment. In a setting table 600 shown in FIG. 6, “narrow street (narrow road)” and “steep slope (mountain road)” are set as a search condition for each vehicle type. The setting table 600 is stored in, for example, the memory of the control device 220 in advance. The setting table 600 is used, for example, in performing a route search of a recommended route (a recommended route according to a vehicle type) with the center server 200 (route search unit 222).

Specifically, when a route search of a recommended route (a recommended route according to a vehicle type) is performed, the route search unit 222 first specifies a vehicle type corresponding to the user of the smartphone 100. For example, for the user of the smartphone 100, vehicle type information of a vehicle used by the user is linked with the user ID of the user. With the above, the route search unit 222 can specify the vehicle type corresponding to the user.

The route search unit 222 acquires a search condition associated with the specified vehicle type from the setting table 600. For example, in a case where the vehicle type corresponding to the user of the smartphone 100 is a “vehicle type A”, the route search unit 222 acquires “OK” as “narrow street (narrow road)” and acquires “NG” as the search condition “steep slope (mountain road)” from the setting table 600. For example, in a case where the vehicle type corresponding to the user of the smartphone 100 is a “vehicle type B”, the route search unit 222 acquires “NG” as “narrow street (narrow road)” and acquires “OK” as the search condition “steep slope (mountain road)” from the setting table 600.

Then, the route search unit 222 searches for the recommended route (the recommended route according to the vehicle type) to the destination using the search condition acquired from the setting table 600. For example, in a case where the vehicle type corresponding to the user of the smartphone 100 is the “vehicle type A”, the route search unit 222 searches for the recommended route (the recommended route according to the vehicle type) to the destination while enabling the use of a road corresponding to “narrow street (narrow road)” and disabling the use of a road corresponding to “steep slope (mountain road)”. For example, in a case where the vehicle type corresponding to the user of the smartphone 100 is the “vehicle type B”, the route search unit 222 searches for the recommended route (the recommended route according to the vehicle type) to the destination while disabling the use of a road corresponding to “narrow street (narrow road)” and enabling the use of a road corresponding to “steep slope (mountain road)”.

As described above, the route search unit 222 applies a search condition by vehicle type set in the setting table 600, thereby searching a suitable recommended route according to a vehicle type used by the user of the smartphone 100.

As described above, with the smartphone 100 according to the embodiment, each time the shake operation is detected in the smartphone 100, it is possible to switch a route displayed on the display 102 to another search theme-specific route among the search theme-specific routes. With the above, a point and a road to go through vary greatly between a route previously displayed and a route next displayed as the search theme changes. For this reason, it is possible to allow the user to easily distinguish the differences among the routes. Accordingly, with the smartphone 100 according to the embodiment, it is possible to switch and display the routes such that the user can easily distinguish the differences among the routes.

Although the preferred embodiment of the present disclosure has been described above in detail, the present disclosure is not limited to the above-described embodiment, and various modifications or alterations may be made without departing from the spirit and scope of the present disclosure described in the claims.

For example, in the embodiment, although via-points on the route to the destination are not described, in a case where one via-point or a plurality of via-points is set from the smartphone 100, the center server 200 may search the search theme-specific routes through one via-point or the via-points.

In the embodiment, although the shake operation of the smartphone 100 is used as the “predetermined random display operation”, the present disclosure is not limited thereto. For example, a selection operation of a predetermined button displayed on the display 102, a flick operation with the input device 101 (touch panel), or the like may be used as the “predetermined random display operation”.

In the embodiment, a part (for example, a route search function) of the functions provided in the center server 200 may be provided in the smartphone 100.

In the embodiment, a part of the functions provided in the smartphone 100 may be provided in the center server 200.

In the embodiment, although the smartphone 100 is used as an example of a navigation terminal, the functions of the navigation terminal may be realized by an information processing apparatus (for example, a tablet terminal, an in-vehicle car navigation device, or the like) other than the smartphone.

In the embodiment, although the center server 200 is used as an example of a navigation server, the functions of the navigation server may be realized by an information processing apparatus (for example, an in-vehicle car navigation device) other than the center server.

What is claimed is:

1. A navigation device comprising:
a display unit;
an operation detection unit configured to detect a predetermined random display operation in the navigation device; and
a display controller configured to make the display unit display one search theme-specific route among a plurality of search theme-specific routes searched by an internal or external route search unit,
wherein the display controller switches a route displayed on the display unit to another search theme-specific route among the search theme-specific routes each time the predetermined random display operation is detected by the operation detection unit.

2. The navigation device according to claim 1, wherein the predetermined random display operation is a shake operation of the navigation device.

3. The navigation device according to claim 1, wherein the display controller makes another search theme-specific route having a larger route difference from one search theme-specific route previously displayed be next displayed in a preferential manner in performing display switching of the search theme-specific routes.
